(19) United States
(12) Patent Application Publication
(10) Pub. No.: US 2014/0184131 A1
(43) Pub. Date: Jul. 3, 2014

(54) METHOD AND APPARATUS OF CONTROLLING SWITCHED RELUCTANCE MOTOR

(71) Applicant: SAMSUNG ELECTRO-MECHANICS CO., LTD., Suwon-si (KR)

(72) Inventors: Jin Wook BAEK, Suwon-si (KR); Han Kyung Bae, Suwon-si (KR); Guen Hong Lee, Suwon-si (KR)

(73) Assignee: SAMSUNG ELECTRO-MECHANICS CO., LTD., Suwon-si (KR)

(21) Appl. No.: 14/140,994

(22) Filed: Dec. 26, 2013

(30) Foreign Application Priority Data
Dec. 28, 2012 (KR) 10-2012-0157077

(51) Int. Cl. H02P 6/08

(52) U.S. Cl. CPC H02P 6/08
USPC 318/701

(57) ABSTRACT

Disclosed herein are a method and apparatus of controlling a switched reluctance motor (SRM). The method of controlling driving of an SRM, the method includes: sensing a variation of a load of the SRM; and controlling both of a dwell angle and a PWM duty ratio of the SRM according to the variation of the load of the SRM. Therefore, an angle and a current are simultaneously controlled, thereby making it possible to decrease a torque ripple at a low speed and constantly control a torque and rapidly respond to a command speed at a high speed. In addition, a speed and a torque of the SRM may be more precisely controlled.

### CROSS REFERENCE TO RELATED APPLICATION

This application claims the benefit of Korean Patent Application No. 10-2012-0157077, filed on Dec. 28, 2012, entitled “The Method of Controlling Switch Reluctance Motor and Apparatus Using the Same”, which is hereby incorporated by reference in its entirety into this application.

### BACKGROUND OF THE INVENTION

1. Technical Field

The present invention relates to a method and apparatus of controlling a switched reluctance motor (SRM).

2. Description of the Related Art

A switched reluctance motor (SRM) is one of the old motors that have been used over 150 years. This traditional type of reluctance motor has been known as the switched reluctance motor in order to satisfy a condition of a variable drive in accordance with the development of a power semiconductor. ‘Switched Reluctance’ was named by S. A. Nasar and has described two main features of the SRM. First, ‘Switched’ means that a motor should always be operated in a continuous switching mode. This term has been used after applying a new type of power semiconductor in accordance with development and advance of the new type of power semiconductor. Second, ‘Reluctance’ means a double salient pole type structure in which a rotor and a stator are operated by varying a reluctance magnetic circuit.

Scholars such as Nasra, French, Koch, Lawrenson had devised a continuous mode control using a power semiconductor unlike a structurally similar stepping motor, in the 1960s. At that time, since only a power thyristor semiconductor has a function of controlling a relatively high voltage and current, it has been used to control the switched reluctance motor. At the present time, a power transistor, a gate turn-off thyristor (GTO), an insulated gate bipolar mode transistor IGBT, a power metal oxide semiconductor field effect transistor (MOSFET), and the like, have been developed and variously used in a rated power range for controlling the SRM.

The SRM has a very simple structure. The SRM does not include a permanent magnet, a brush, and a commutator. In this SRM, a stator includes salient poles and has a structure in which steels are stacked, and winding around which coils connected in series with each other are wound are independently connected to the respective phases and enclose stator poles. A rotor does not include a winding, has a structure in which steels are stacked, and includes salient poles, similar to the stator. Therefore, since both of the stator and the rotor have the salient pole structure, the SRM may be considered as having a double salient pole type structure. Due to this simple structure, reliability is increased and a production cost is decreased, it is like the SRM will substitute for a variable speed drive.

The following Prior Art Document (Patent Document) KR2002-0003781 relates a method of detecting a position of a rotor in a switched reluctance motor. More specifically, KR2002-0003781 has disclosed a method of measuring the position of the rotor in the SRM without attaching an additional position sensor such as an encoder.

### PRIOR ART DOCUMENT

### Patent Document

(Patent Document 1) KR2002-0003781

### SUMMARY OF THE INVENTION

The present invention has been made in an effort to provide a method of controlling driving of a switched reluctance motor (SRM) according to a variation of a load.

Further, the present invention has been made in an effort to provide an apparatus of controlling driving of an SRM according to a variation of a load.

According to a preferred embodiment of the present invention, there is provided an apparatus of controlling driving of an SRM, the apparatus including: a load sensing unit sensing a variation of a load of the SRM; and a controlling unit controlling both of a dwell angle and a pulse width modulation (PWM) duty ratio of the SRM according to the variation of the load of the SRM.

The variation of the load of the SRM may be a variation of a revolution per minute (RPM) of the SRM.

The controlling unit may be implemented to increase the dwell angle and the PWM duty ratio of the SRM at a predetermined ratio in the case in which the RPM of the SRM is increased.

The controlling unit may be implemented to decrease the dwell angle and the PWM duty ratio of the SRM at a predetermined ratio in the case in which the RPM of the SRM is decreased.

The load sensing unit may be implemented to judge whether or not the variation of the RPM of the SRM exceeds a specific threshold, and the controlling unit may be implemented to increase or decrease both of the dwell angle and the PWM duty ratio of the SRM at a predetermined ratio according to the variation of the RPM in the case in which the variation of the RPM exceeds the specific threshold.

According to another preferred embodiment of the present invention, there is provided a method of controlling driving of an SRM, the method including: sensing a variation of a load of the SRM; and controlling both of a dwell angle and a PWM duty ratio of the SRM according to the variation of the load of the SRM.

The sensing of the variation of the load of the SRM may include sensing a variation of an RPM of the SRM.

The controlling of both of the dwell angle and the PWM duty ratio of the SRM according to the variation of the load may include increasing the dwell angle and the PWM duty ratio of the SRM at a predetermined ratio in the case in which the RPM of the SRM is increased.

The controlling of both of the dwell angle and the PWM duty ratio of the SRM according to the variation of the load may include decreasing the dwell angle and the PWM duty ratio of the SRM at a predetermined ratio in the case in which the RPM of the SRM is decreased.

The controlling of both of the dwell angle and the PWM duty ratio of the SRM according to the variation of the load may include: judging whether or not the variation of the RPM of the SRM exceeds a specific threshold, and increasing or decreasing both of the dwell angle and the PWM duty ratio of the SRM at a predetermined ratio according to the variation of the RPM in the case in which the variation of the RPM exceeds the specific threshold.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a conceptual diagram showing a structure of a switched reluctance motor (SRM) according to a preferred embodiment of the present invention;

FIGS. 2A to 2C are conceptual diagrams showing an inductance and a torque according to a position of a rotor in the SRM according to the preferred embodiment of the present invention;

FIG. 3 is a conceptual diagram showing a method of controlling a variation of a load in the SRM according to the preferred embodiment of the present invention;

FIGS. 4A and 4B are conceptual diagrams showing a method of controlling an SRM according to the preferred embodiment of the present invention;

FIGS. 5A and 5B are conceptual diagrams showing a method of controlling an SRM according to the preferred embodiment of the present invention;

FIGS. 6A and 6B are conceptual diagrams showing a method of controlling an SRM according to the preferred embodiment of the present invention;

FIG. 7 is a flow chart showing a method of controlling an SRM according to the preferred embodiment of the present invention; and

FIG. 8 is a flow chart showing an apparatus of controlling an SRM according to the preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

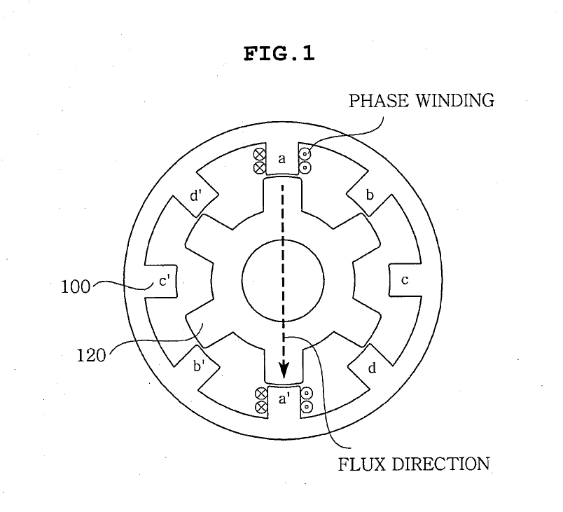

FIG. 1 is a conceptual diagram showing a structure of a switched reluctance motor (SRM) according to a preferred embodiment of the present invention.

In FIG. 1, the SRM having a double salient pole structure in which the numbers of poles of each of a stator 100 and a rotor 120 are 8 and 6, respectively, is shown. Each of the stator 100 and the rotor 120 may be made of a material such as iron having high magnetic permeability and have a structure in which it may be stacked by stratification. A winding is wound around the stator.

Driving characteristics of the SRM will be simply described. When the pole of the stator of the SRM is excited, the rotor 120 corresponding to the stator is induced to the stator 100 excited so that a reluctance of a magnetic circuit is minimized. Therefore, when the rotor 120 approaches the corresponding stator 100, the winding of the next stator 100 is excited, thereby making it possible to obtain a predetermined torque.

That is, when a current flows in a phase of the stator 100, a torque allowing the rotor 120 to be rotated in a direction in which an inductance is increased until the rotor 120 is positioned at a position at which it has a maximum inductance value is generated. When a magnetization component does not remain in an iron core, a direction of the current is not related to a polarity of the torque, which is always generated in a direction in which the rotor 120 is to move to an alignment position closest thereto.

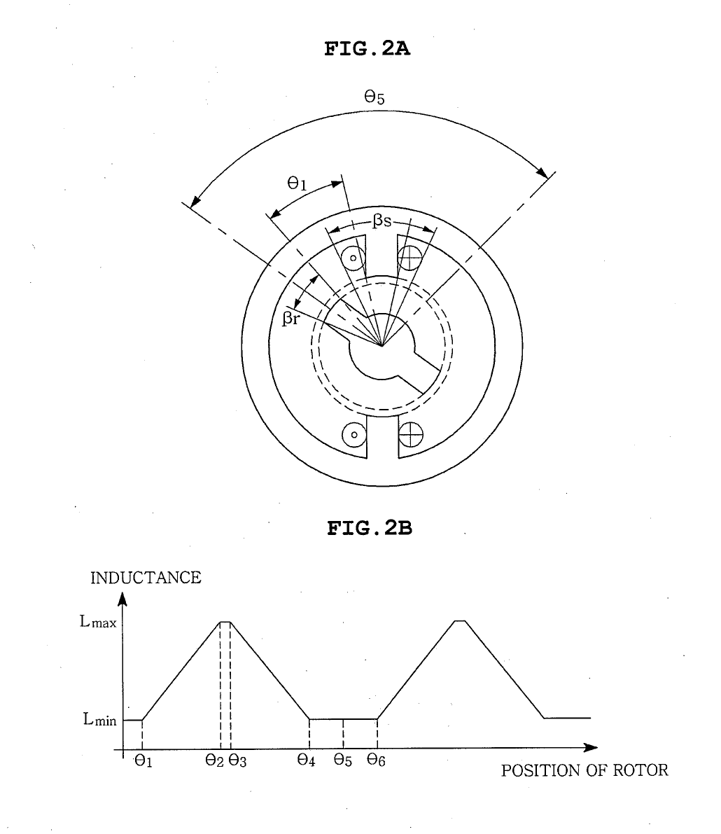

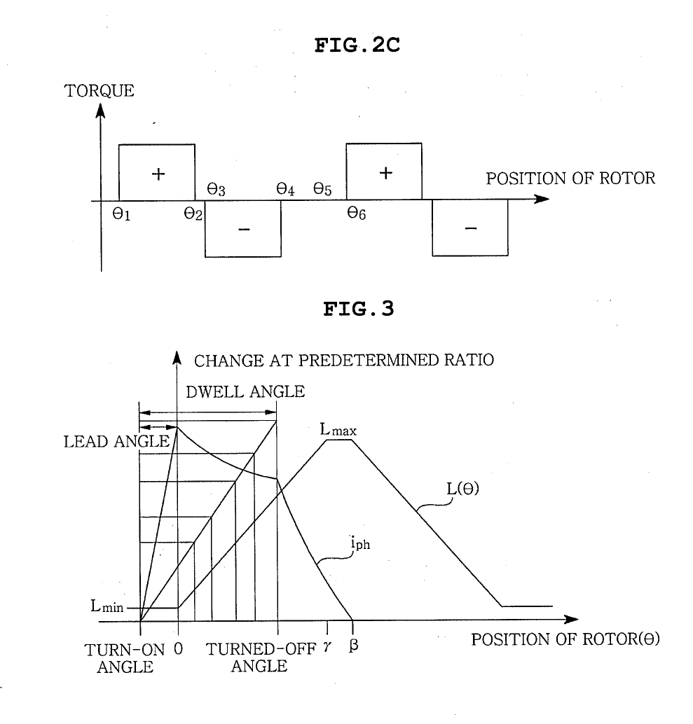

When the current continuously flows during one period of the inductance, a polarity of the torque according to the position of the rotor will be described in detail with reference to FIG. 2.

According to the preferred embodiment of the present invention, in the case in which the variation of the load (a variation of an RPM) is sensed in the SRM, a method of controlling both of a dwell angle and a pulse width modulation (PWM) duty ratio at a predetermined ratio to rapidly respond to the variation of the load of the SRM is disclosed.

(1) The dwell angle indicates a difference between a turn-off angle and a turn-on angle when it is assumed that a position of the rotor at which a stator current is switched on in the SRM is the turn-on angle and a position of the rotor at which the stator current is switched off in the SRM is the turn-off angle. That is, the dwell angle may be a section in which a switch of an inverter is turned on. The dwell angle is changed, thereby making it possible to respond to the variation of the load of the SRM.

(2) The PWM is a method of controlling the entire average voltage using a width of a pulse. The pulse may have a waveform in which a high signal and a low signal intersect with each other at a predetermined timing, and a ratio between lengths of the high signal and the low signal is called a duty ratio. In the case in which the duty ratio is high, since the length of the high signal becomes long, the average voltage may rise. For example, when the PWM duty ratio is 5%, it means that in the case in which a period is 100 seconds, the length of the high signal is 5 seconds and the length of the low signal is 95 seconds.

Hereinafter, in the preferred embodiment of the present invention, a method of responding to the variation of the load of the SRM based on the dwell angle and the duty ratio will be described.

FIG. 2 is a conceptual diagram showing an inductance and a torque according to a position of a rotor in the SRM according to the preferred embodiment of the present invention.

FIG. 2A shows a position of a rotor in the SRM. βₛ and βᵣ indicate pole arcs of the stator and the rotor, respectively. A period of an inductance curve of one phase is the same as an angle between two rotor poles neighboring to each other, that is, a rotor pole pitch (τ), which becomes a period of an inductance profile.

In the case of a 8/6 motor, inductance curves of the respective phases are change while having a phase difference therebetween. Therefore, in order to continuously rotate the motor, the respective phases should be sequentially switched to allow the current to flow only in a section in which the inductances of the respective phases increase, thereby generating a torque in a predetermined direction.

Referring to FIG. 2C, the torque is in proportion to a square of the current, such that it may be generated regardless of a direction of a phase current, and a positive torque or a negative torque may be generated as the torque according to a change ratio of the inductance.

As shown in FIG. 2B, there are periods in which the inductance increases, decreases, or is constant. When a predetermined exiting current flows in a phase winding, the positive torque is generated in the section in which the inductance increases, and the negative torque having the same magnitude as that of the positive torque is generated in the section in which the inductance is decreased.

Therefore, when the predetermined exiting current is applied to the SRM, since the positive torque and the negative torque are offset against each other, the torque of the SRM becomes 0, such that a rotation torque may not be obtained. Therefore, in order to prevent generation of the negative torque and obtain an effective rotation torque, it is necessarily required to detect a position angle of the rotor and perform switching excitation according to the position angle. That is, the switching exciting current should flow in each phase of the SRM to generate an ideal torque.

FIG. 3 is a conceptual diagram showing a method of controlling a variation of a load in the SRM according to the preferred embodiment of the present invention.

In FIG. 3, an inductance profile according to a position angle of the rotor and an exiting current waveform by switching of a stator phase are shown.

According to the preferred embodiment of the present invention, as the method of controlling a variation of a load in the SRM, a method of changing both of the dwell angle and the PWM duty ratio is used, thereby making it possible to change the exciting current waveform.

For example, the dwell angle and the PWM duty ratio may be changed at a predetermined ratio.

For example, when it is assumed that the PWM duty ratio is changed between 10 to 100% and the dwell angle is 60 to 15 degrees, a change width of the PWM duty ratio may be 90%, and a change width of the dwell angle may be 45 degrees. In this case, when the PWM duty ratio is changed by 1%, the dwell angle is changed by 0.5 degree, thereby making it possible to control the load of the SRM.

In the case in which the dwell angle and the PWM duty are changed, the following changes may occur in the SRM.

1) The dwell angle indicates the difference between the turn-off angle and the turn-on angle when it is assumed that the position of the rotor at which the stator current is switched on is the turn-on angle and the position of the rotor at which the stator current is switched off in the SRM is the turn-off angle, as described above. A lead angle (θ_{AD}) indicates a section in which power is applied to the winding to excite the winding. In the case in which the lead angle is changed, a turn-on point in time is shifted ahead, such that a current rising time is changed. The dwell angle and the lead angle are changed, thereby making it possible to adjust a revolution per minute (RPM) of the SRM. For example, the lead angle is adjusted to shift the turn-on point in time ahead, thereby making it possible to make a current rising time sufficient, and the dwell angle is adjusted to use a torque generation region as much as possible but minimize a magnitude of the current before a section in which the negative torque is generated is reached, thereby making it possible to suppress the generation of the negative torque. That is, in the case in which the dwell angle is adjusted, the torque generation region may be used as much as possible, but the magnitude of the current may be minimized before the section in which the negative torque is generated is reached.

In addition, since torque characteristics of the SRM is unrelated to a direction of the current and has the same sign as that of a gradient of the inductance, it is impossible to rotate the SRM in a reverse direction by controlling only the current. Therefore, in order to rotate the SRM in a forward or reverse direction, it is required to control the angle to allow the current to flow in a section in which a torque is generated in a desired rotation direction. In addition, the angle control may also be used at the time of sudden braking.

That is, in the case in which the dwell angle is changed, the section in which the torque is generated is changed in the SRM, thereby making it possible to control the variation of the load of the SRM.

2) In the case of changing the PWM duty ratio, the current flowing in the SRM is controlled, thereby making it possible to control the variation of the load of the SRM. A method of changing the PWM duty to control the variation of the load of the SRM may be mainly used to control the SRM driven at a low speed or a medium speed.

In the case of the SRM driven at the low speed or the medium speed, since back electromotive force and an increase in the inductance of the SRM are slowly generated, a rising ratio of the current by an applied voltage is large, such that a peak current may be larger than a peak current of the SRM driven at a high speed. In order to limit this current to be smaller than a current of a switching device, the switching device is turned on or turned of by chopping, thereby making it possible to control the SRM at a desired speed.

That is, in the case in which both of the dwell angle and the PWM duty ratio, which are two control elements of the load of the SRM, are changed, the variation of the load of the SRM may be more effectively controlled. The angle and the current are simultaneously controlled, thereby making it possible to decrease a torque ripple at a low speed and constantly control the torque and rapidly respond to a command speed at a high speed. In addition, the speed and the torque of the SRM may be more precisely controlled.

Further, according to the preferred embodiment of the present invention, a method of controlling both of the two control elements to control the variation of the load may be used in combination with a method of controlling an operation of the SRM using one control element Hereinafter, in the preferred embodiment of the present invention, these methods will be described.

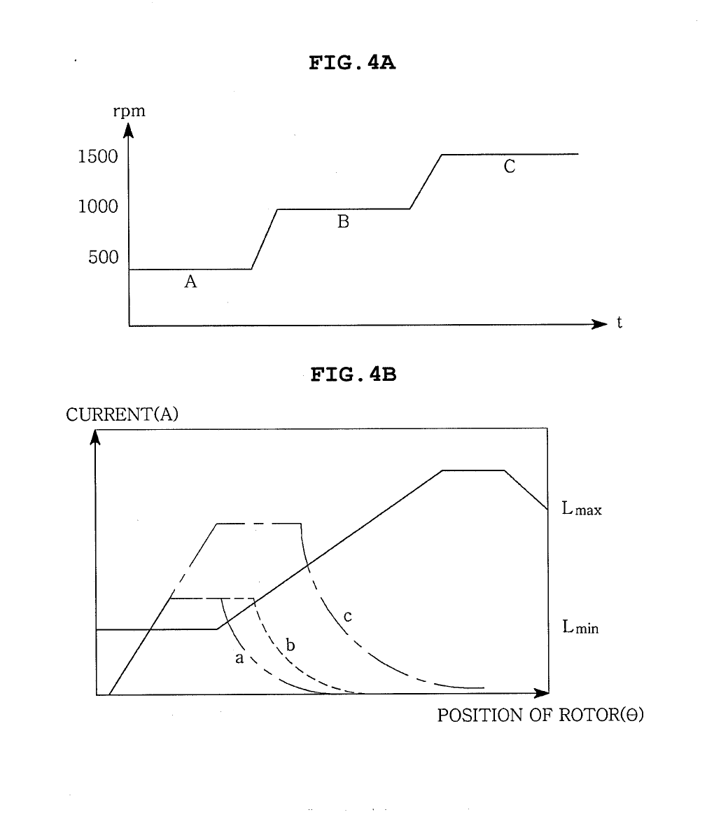

FIGS. 4A and 4B are conceptual diagrams showing a method of controlling an SRM according to the preferred embodiment of the present invention.

In FIGS. 4A and 4B, the method of controlling an operation of the SRM by increasing only the dwell angle to increase the RPM of the SRM and then controlling both of the dwell angle and the PWM duty ratio when the RPM of the SRM exceeds a specific RPM in controlling the load of the SRM is shown.

Referring to FIG. 4A, the RPM of the SRM may be increased from 500 to 1000 and from 1000 to 1500. Section A is a section in which the RPM of the SRM is 500, second B is a section in which the RPM of the SRM is 1000, and section C is a section in which the RPM of the SRM is 1500.

For example, in the RPM less than 1000, the RPM of the SRM is controlled using only the dwell angle as an SRM control variable, and in the RPM of 1000 or more, the RPM of the SRM is controlled by both of the dwell angle and the PWM duty ratio. That is, different methods of controlling the operation of the SRM may be selected based on a specific RPM of the SRM.

FIG. 4B is a conceptual diagram showing a current waveform according to an operation section.

1) In section A, a phase current may have a current waveform a. In a current waveform b in the case in which the RPM of the SRM is increased from 500 to 1000, a dwell angle is increased as compared with the current waveform a in the case in which the RPM of the SRM is 500, such that an effective torque generation section is increased, thereby making it possible to increase the RPM of the SRM.

2) In section C, the phase current may have a current waveform c. In the case in which the RPM of the SRM is increased from 1000 to 1500, a value of a phase current and the dwell angle are adjusted, thereby making it possible to increase the effective torque generation section. That is, when the sensed RPM of the SRM exceeds a specific value, the variation of the load of the SRM may be controlled using both of two control variables.

Although a specific RPM has been shown as a condition for changing the control variable in FIGS. 4A and 4B, a control variable for controlling the operation of the SRM may also be changed under a condition other than the specific RPM, and this embodiment may also fall within the scope of the present invention.

In addition, although only the case in which the RPM of the SRM is increased has been shown by way of example in FIGS. 4A and 4B, the above-mentioned embodiment may also be applied to the case in which the RPM of the SRM is decreased. That is, when the RPM is decreased, the number of control variables for controlling the driving of the SRM may be decreased from two control variables (the dwell angle and the PWM duty ratio) to one control variable (the dwell angle or the PWM duty ratio).

The above-mentioned embodiment is only an example. That is, it is also possible to control the operation of the SRM using the PWM duty ratio and then control the operation of the SRM using both of the dwell angle and the PWM duty ratio in the case in which a specific condition is satisfied.

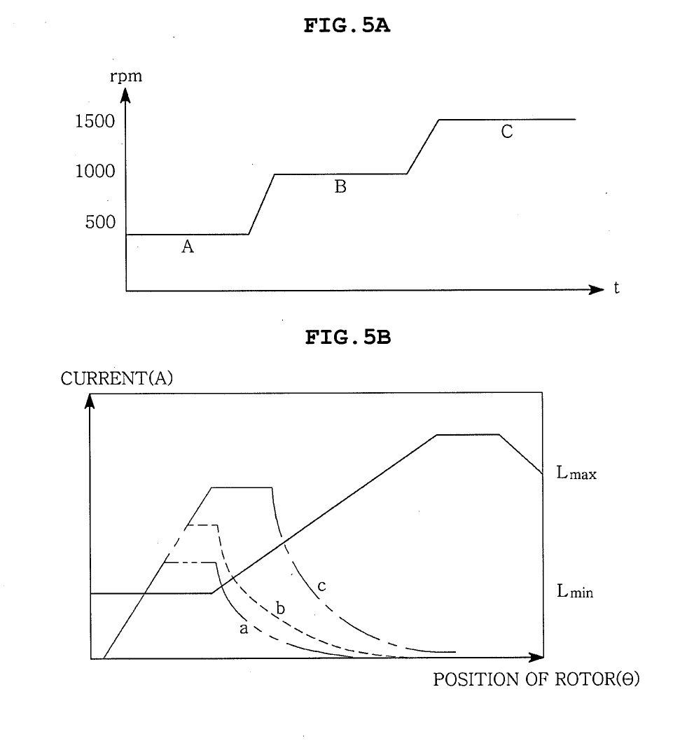

FIGS. 5A and 5B are conceptual diagrams showing a method of controlling an SRM according to the preferred embodiment of the present invention.

In FIGS. 5A and 5B, the method of controlling an operation of the SRM by increasing only the PWM duty ratio to increase the RPM of the SRM and then controlling both of the PWM duty ratio and the dwell angle when the RPM of the SRM exceeds a specific RPM in controlling the operation of the SRM is shown. It is also possible to control the operation of the SRM using a variable other than the RPM of the SRM.

Referring to FIG. 5A, the RPM of the SRM may be increased from 500 to 1000 and from 1000 to 1500. Section A is a section in which the RPM of the SRM is 500, second B is a section in which the RPM of the SRM is 1000, and section C is a section in which the RPM of the SRM is 1500.

For example, in the RPM less than 1000, the RPM of the SRM is controlled using only the PWM duty ratio as an SRM control variable, and in the RPM of 1000 or more, the RPM of the SRM is controlled by both of the dwell angle and the PWM duty ratio. That is, different methods of controlling the operation of the SRM may be selected based on a specific RPM of the SRM.

FIG. 5B is a conceptual diagram showing a current waveform according to an operation section.

1) In section A, a phase current may have a current waveform a. In a current waveform b in the case in which the RPM of the SRM is increased from 500 to 1000, a value of a phase current is increased as compared with the current waveform a in the case in which the RPM of the SRM is 500, such that an effective torque generation section is increased, thereby making it possible to increase the RPM of the SRM.

2) In section C, the phase current may have a current waveform c. In the case in which the RPM of the SRM is increased from 1000 to 1500, a value of a phase current and the dwell angle are adjusted, thereby making it possible to increase the effective torque generation section. That is, when the sensed RPM of the SRM exceeds a specific value, the variation of the load of the SRM may be controlled using both of two control variables.

Also in FIGS. 5A and 5B, a control variable for controlling the operation of the SRM may also be changed under a condition other than the RPM of the SRM, and this embodiment may also fall within the scope of the present invention.

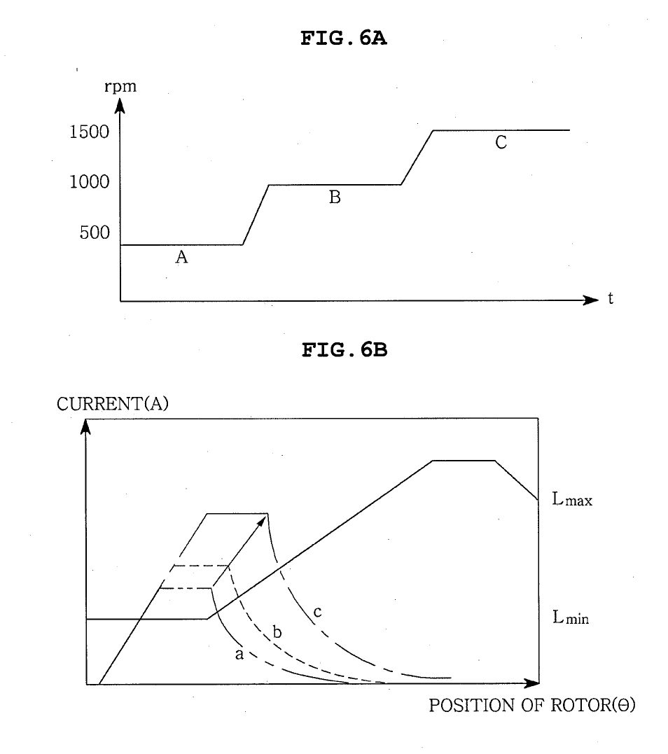

FIGS. 6A and 6B are conceptual diagrams showing a method of controlling an SRM according to the preferred embodiment of the present invention.

In FIGS. 6A and 6B, a method of controlling an operation of the SRM by changing the PWM duty ratio and the dwell angle at a predetermined ratio in the embodiment of FIG. 5 is shown.

Referring to FIG. 6A, in the case (section G) in which the RPM of the SRM is decreased from 1500 to 1300 and the case (section H) in which the RPM of the SRM is increased from 1500 to 1800, the RPM of the SRM may be controlled by changing the PWM duty ratio and the dwell angle at a predetermined ratio.

Referring to FIG. 6B, in the section G, the PWM duty ratio and the dwell angle may be decreased at the predetermined ratio. In the case in which the PWM duty ratio and the dwell angle are decreased at the predetermined ratio, the phase current may have a current wave form g. Therefore, the RPM of the SRM may be decreased.

To the contrary, in section H, the PWM duty ratio and the dwell angle may be increased at the predetermined ratio. In the case in which the PWM duty ratio and the dwell angle are increased at the predetermined ratio, the phase current may have a current wave form h. Therefore, the RPM of the SRM may be increased.

FIG. 7 is a flow chart showing a method of controlling an SRM according to the preferred embodiment of the present invention.

In FIG. 7, a method of controlling the RPM of the SRM by increasing or decreasing the dwell angle and the PWM duty ratio according to the RPM of the SRM at a predetermined ratio is shown.

Referring to FIG. 7, whether or not the RPM of the SRM will be changed is judged (S700).

A value of the RPM of the SRM may be measured by an RPM sensing unit, and whether the value will be increased or decreased may be judged to increase or decrease the dwell angle and the PWM duty ratio at a predetermined ratio. In the case in which both of the dwell angle and the PWM duty ratio, which are two control elements, are changed, the variation of the load of the SRM may be more effectively controlled. The angle and the current are simultaneously controlled, thereby making it possible to decrease a torque ripple at a low speed and constantly control the torque and rapidly respond to a command speed at a high speed. In addition, the speed and the torque of the SRM may be more precisely controlled.

In the case of increasing the RPM of the SRM, the dwell angle and the PWM duty ratio are increased at a predetermined ratio (S710).

As described above, for example, a change width (for example, 10 to 100%) of the PWM duty ratio and a change width (for example, 60 to 15 degrees) of the dwell angle may be increased at a predetermined ratio.

In the case of decreasing the RPM of the SRM, the dwell angle and the PWM duty ratio are decreased at a predetermined ratio (S720).

In the case in which both of the dwell angle and the PWM duty ratio are controlled only when the RPM of the SRM is a specific value or more and only one of the dwell angle and the PWM duty ratio is controlled when the RPM of the SRM is less than the specific value, the method of controlling an SRM may further include, before steps shown in FIG. 7, judging whether the RPM of the SRM to be controlled is the specific value or more to judge which control variable will be used to control the SRM.

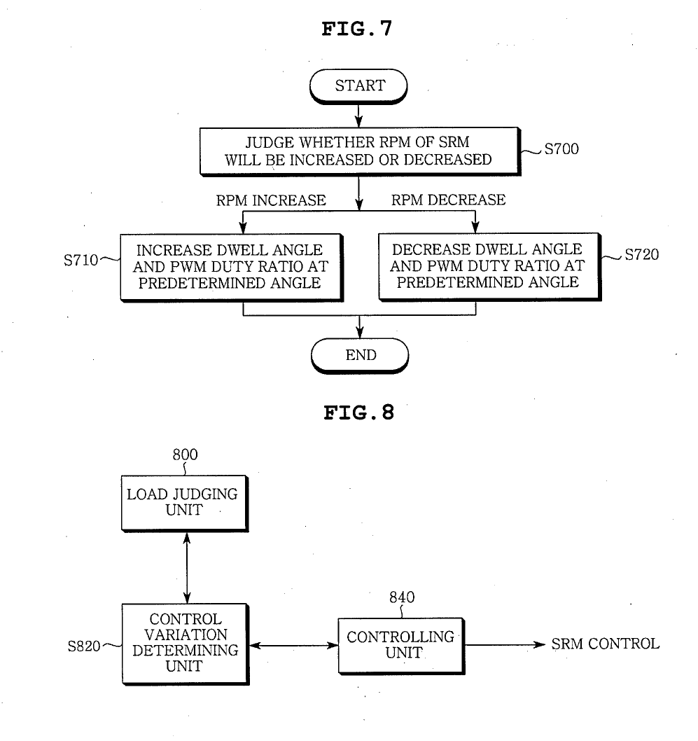

FIG. 8 is a flow chart showing an apparatus of controlling an SRM according to the preferred embodiment of the present invention.

Referring to FIG. 8, the apparatus of controlling an SRM may include a load judging unit 800, a control variable determining unit 820, and a controlling unit 840.

The respective components will be separately represented according to a function thereof for convenience of explanation. The respective components may again be implemented to be divided into a plurality of components or the plurality of components be implemented to be integrated in one component.

The load judging unit 800 may judge a current RPM of the SRM or determine a target RPM of the SRM and transmit information on the target RPM to the control variable determining unit 820 to allow the control variable determining unit 820 to determine a variable for controlling the SRM.

The control variable determining unit 820 may determine based on which control variable the control will be performed. As in the above-mentioned example, the control variable determining unit 820 may make a determination so that the operation of the SRM is controlled using only one control variable (the dwell angle or the PWM duty ratio) in the case in which the RPM is a specific value or less and so that the operation of the SRM is controlled using both of two control variables (the dwell angle and the PWM duty ratio) in the case in which the RPM exceeds the specific value.

The controlling unit 840, which is a unit controlling the operation of the SRM, may change the control variable determined by the control variable determining unit 820 to control the operation of the SRM. In the method of controlling driving of the SRM according to the preferred embodiment of the present invention, the driving of the SRM may be controlled by changing both of two control variables (the dwell angle and the PWM duty ratio).

In the case of controlling the driving of the SRM by changing both of the dwell angle and the PWM duty ratio, the apparatus of controlling an SRM may include only the load judging unit 800 and the controlling unit 840 without the control variable determining unit 820. This embodiment may also fall in the scope of the present invention.

As set forth above, with the method and apparatus of controlling an SRM according to the preferred embodiments of the present invention, the variation of the load of the SRM may be sensed, and both of the dwell angle and the PWM duty ratio of the SRM may be controlled according to the variation of the load of the SRM. Therefore, the angle and the current are simultaneously controlled, thereby making it possible to decrease a torque ripple at a low speed and constantly control the torque and rapidly respond to a command speed at a high speed. In addition, the speed and the torque of the SRM may be more precisely controlled.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus of controlling driving of a switched reluctance motor (SRM), the apparatus comprising:
a load sensing unit sensing a variation of a load of the SRM; and
a controlling unit controlling both of a dwell angle and a pulse width modulation (PWM) duty ratio of the SRM according to the variation of the load of the SRM.

2. The apparatus as set forth in claim 1, wherein the variation of the load of the SRM is a variation of a revolution per minute (RPM) of the SRM.

3. The apparatus as set forth in claim 2, wherein the controlling unit is implemented to increase the dwell angle and the PWM duty ratio of the SRM at a predetermined ratio in the case in which the RPM of the SRM is increased.

4. The apparatus as set forth in claim 2, wherein the controlling unit is implemented to decrease the dwell angle and the PWM duty ratio of the SRM at a predetermined ratio in the case in which the RPM of the SRM is decreased.

5. The apparatus as set forth in claim 2, wherein the load sensing unit is implemented to judge whether or not the variation of the RPM of the SRM exceeds a specific threshold, and
the controlling unit is implemented to increase or decrease both of the dwell angle and the PWM duty ratio of the SRM at a predetermined ratio according to the variation of the RPM in the case in which the variation of the RPM exceeds the specific threshold.

6. A method of controlling driving of an SRM, the method comprising:
sensing a variation of a load of the SRM; and
controlling both of a dwell angle and a PWM duty ratio of the SRM according to the variation of the load of the SRM.

7. The method as set forth in claim 6, wherein the sensing of the variation of the load of the SRM includes sensing a variation of an RPM of the SRM.

8. The method as set forth in claim 6, wherein the controlling of both of the dwell angle and the PWM duty ratio of the SRM according to the variation of the load includes increasing the dwell angle and the PWM duty ratio of the SRM at a predetermined ratio in the case in which the RPM of the SRM is increased.

9. The method as set forth in claim 6, wherein the controlling of both of the dwell angle and the PWM duty ratio of the SRM according to the variation of the load includes decreasing the dwell angle and the PWM duty ratio of the SRM at a predetermined ratio in the case in which the RPM of the SRM is decreased.

10. The method as set forth in claim 6, wherein the controlling of both of the dwell angle and the PWM duty ratio of the SRM according to the variation of the load includes:
judging whether or not the variation of the RPM of the SRM exceeds a specific threshold, and
increasing or decreasing both of the dwell angle and the PWM duty ratio of the SRM at a predetermined ratio according to the variation of the RPM in the case in which the variation of the RPM exceeds the specific threshold.
